(19) United States
(12) Patent Application Publication
(10) Pub. No.: US 2010/0333190 A1
(43) Pub. Date: Dec. 30, 2010

(54) LATENCY REDUCTION METHOD AND NETWORK CONNECTION APPARATUS

(75) Inventor: Tadafusa NIINOMI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/819,426

(22) Filed: Jun. 21, 2010

(30) Foreign Application Priority Data
Jun. 26, 2009 (JP) 2009-151899

(51) Int. Cl. G06F 21/00; G06F 15/16

(52) U.S. Cl. 726/13

(57) ABSTRACT

A latency reduction method executed by a network connection apparatus, includes starting to output an incoming packet before an access control processing with respect to the incoming packet has completed, and changing the incoming packet to an invalid packet and outputting the invalid packet when determined by the access control processing to discard the incoming packet.

### CROSS-REFERENCE TO RELATED APPLICATIONS

This application is based upon and claims the benefit of priority of the prior Japanese Patent Application No. 2009-151899, filed on Jun. 26, 2009, the entire contents of which are incorporated herein by reference.

### FIELD

The embodiments discussed herein are related to technology for network connection apparatus, such as switches and routers, and method thereof.

### BACKGROUND

In a switch or router, it is sometimes desirable to single out a particular packet by means of user instructions, and then subject that packet to some sort of processing. One function that satisfies such requirements is an access control list (ACL). One example of processing conducted using an ACL is drop/pass processing. In addition, when a particular packet is specified, its MAC addresses (i.e., one or both of the source address (SA) and the destination address (DA)), IP addresses (i.e., one or both of the SA and the DA), or TCP port numbers (one or both of the source port and the destination port) may be specified, for example.

ACL processing typically requires an amount of time in which to determine whether or not a given packet is the specified packet. For example, referencing TCP port numbers involves the time until all packet data up to the TCP port numbers has entered the circuit used for the ACL function. In addition, when carrying out processing to discard a packet relevant to a determination result, the relaying of a given packet cannot be initiated until it is determined whether or not that packet is to be discarded by the ACL function. This is because it would be problematic for the packet to be already partially sent when it is determined that the packet should be discarded. Consequently, packets will accumulate until the determinations are made for the ACL function.

Meanwhile, there exist two packet forwarding techniques in switches: the store-and-forward technique, where an entire packet is first stored in the switch before being output; and the cut-through technique, where a packet is relayed before the whole frame has been received, in order to reduce the delay time for relaying packets (i.e., the latency). If an ACL function is considered for use in conjunction with the cut-through technique, the data accumulation required for ACL determinations will occur, and thus latency values will worsen, even though the cut-through technique is being used.

Meanwhile, there exists technology where, when a packet containing a first part and a second part is received at an input port, cut-through switching of the first part is initiated before all of the second part is received, and errors are detected by using tag data attached to the packet. However, there still remains the question of how to handle the situation when the packet should be discarded, and innovations enabling the use of an ACL function in conjunction with the cut-through technique have yet to be made.

Also, technology has been discussed where header cyclic redundancy check (CRC) checking means is provided in an ATM in order to analyze addressing information after checking the validity of the header. The header CRC checking means checks the validity of the header of an upper-layer protocol data unit (PDU), on the basis of a header CRC following the header of the upper-layer PDU. However, there still remains the question of the processing for the case when it is determined that a cell should be discarded, and innovations enabling the use of an ACL function in conjunction with the cut-through technique have yet to be made.

Thus, as described above, there is a problem in that the worsening of latency values is not curtailed when applying an ACL function to the cut-through technique.

### SUMMARY

According to an embodiment of the invention, a latency reduction method executed by a network connection apparatus is provided, the method includes starting to output an incoming packet before an access control processing with respect to the incoming packet has completed, and changing the incoming packet to an invalid packet and outputting the invalid packet when determining by the access control processing to discard the incoming packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an exemplary configuration of a network connection apparatus that acts as a basic premise of an embodiment;

FIG. 2 illustrates an example of a normal operation of a network connection apparatus that acts as a basic premise of an embodiment;

FIG. 3 illustrates an example of a packet-discarding operation of a network connection apparatus that acts as a basic premise of an embodiment;

FIG. 4 illustrates an exemplary configuration of a network connection apparatus in accordance with an embodiment;

FIG. 5 illustrates an example of a normal operation of a network connection apparatus in accordance with an embodiment;

FIG. 6 illustrates an example of data stored in an FDB;

FIG. 7 illustrates an example of data stored in a control region;

FIG. 8 illustrates an exemplary sequence indicating packet-discarding operation in a network connection apparatus;

FIG. 9 illustrates an example of a format of an ordinary packet;

FIG. 10 illustrates an example of a packet format of an invalid packet;

FIG. 11 illustrates an exemplary process flow for a process at an input port;

FIG. 12 illustrates an exemplary process flow for a forwarding control circuit;

FIG. 13 illustrates an exemplary process flow for a forwarding control circuit;

FIG. 14 illustrates an exemplary process flow at an output port;

FIG. 15 illustrates an exemplary process flow for a latency reduction method; and

FIG. 16 illustrates an exemplary configuration of a network connection apparatus.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

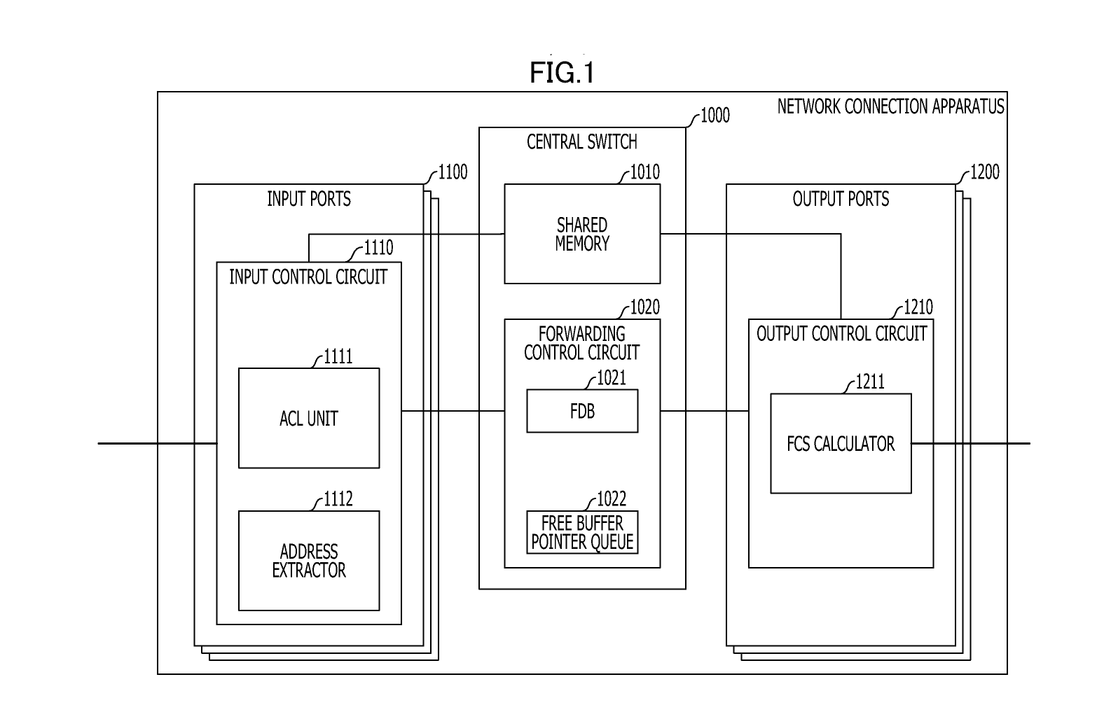

First, the configuration and operation of a switch or similar network connection apparatus will be described for the case of simply applying an ACL function to the cut-through technique. FIG. 1 is a function block diagram illustrating a network connection apparatus for such a case. The network connection apparatus includes a plurality of input ports 1100, a central switch 1000, and a plurality of output ports 1200. Each of the input ports 1100 includes an input control circuit 1110. The input control circuit 1110 includes an ACL unit 1111 that carries out an access control processing, and an address extractor 1112 that extracts DAs, SAs, and Virtual Local Area Network IDs (VLANIDs) from packets (also referred to as frames). The central switch 1000 includes a shared memory 1010 and a forwarding control circuit 1020. The forwarding control circuit 1020 includes a forwarding database (FDB) 1021 and a free buffer pointer queue 1022. Each of the output ports 1200 includes an output control circuit 1210. The output control circuit 1210 is provided with a frame check sequence (FCS) calculator 1211. Both the respective input control circuits 1110 of the input ports 1100 as well as the respective output control circuits 1210 of the output ports 1200 are connected to the shared memory 1010 and the forwarding control circuit 1020.

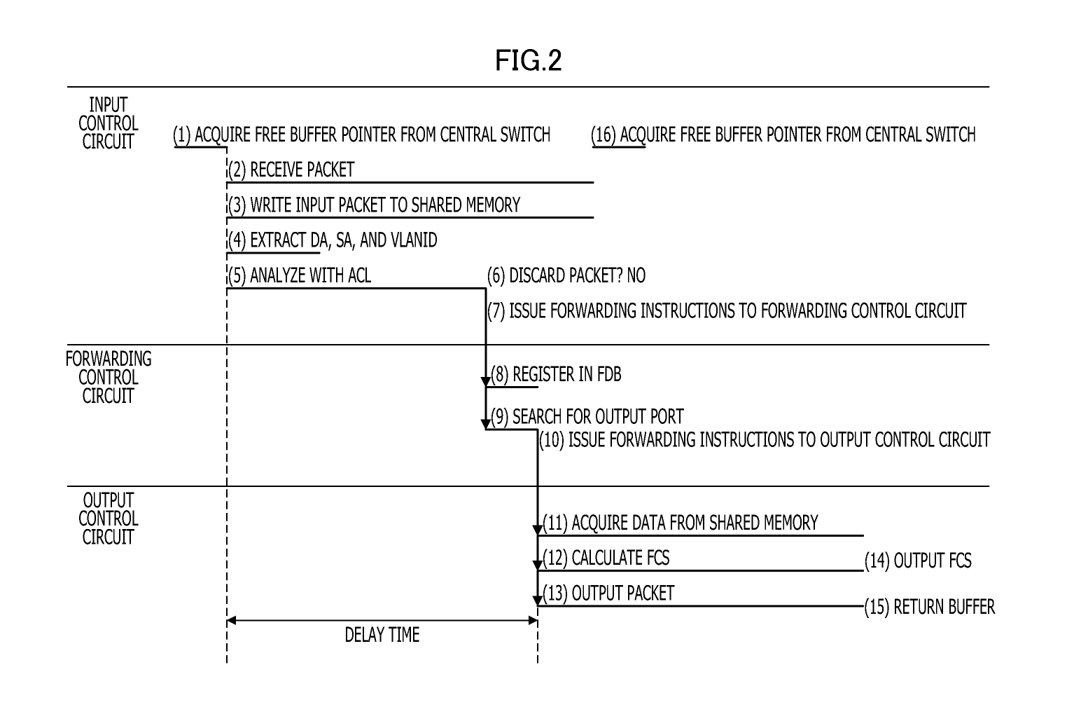

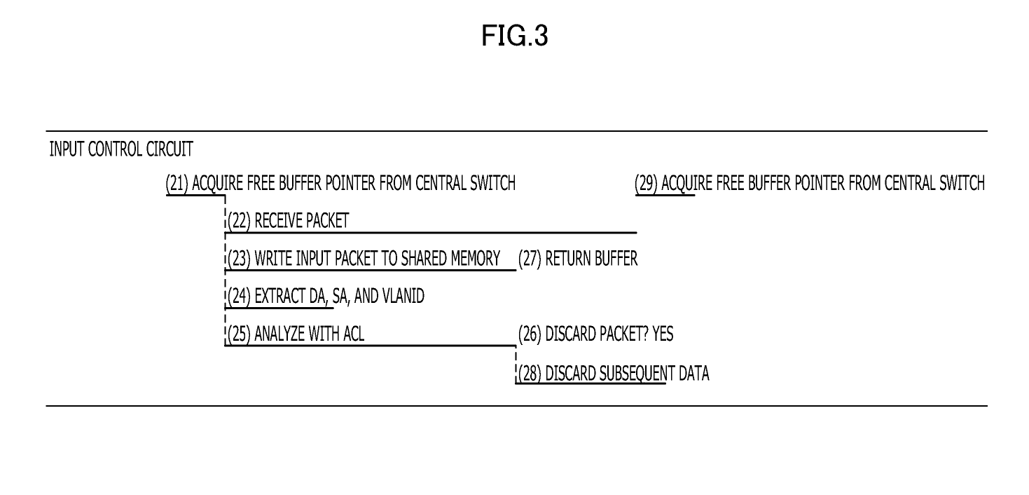

Operation of the network connection apparatus in FIG. 1 will now be described using FIGS. 2 and 3. First, the input control circuits 1110 of the input ports 1100 respectively acquire, from the forwarding control circuit 1020, a free buffer pointer registered in the free buffer pointer queue 1022, which points to a free region within the shared memory 1010 (operation (1)). Subsequently, when a packet arrives at one of the input ports 1100, that input port 1100 receives the packet (operation (2)), and also begins to write the packet data to the region in the shared memory 1010 indicated by the free buffer pointer (operation (3)). Also, at the same time, the address extractor 1112 of the input control circuit 1110 extracts the DA, SA, and VLANID from the incoming packet (operation (4)), and the ACL unit 1111 initiates analysis of the incoming packet (operation (5)). Meanwhile, however, neither the central switch 1000 nor the output ports 1200 perform any particular action until the analysis by the ACL unit 1111 ends. For this reason, the latency (i.e., the delay time) increases.

If the ACL unit 1111 subsequently finishes analysis of the incoming packet and determines that, for example, the packet is not to be discarded (operation (6)), then the ACL unit 1111 outputs forwarding instructions to the forwarding control circuit 1020 (operation (7)). The forwarding instructions include the DA, SA, and VLANID, as well as the buffer pointer for the region in the shared memory 1010 where the incoming packet data is being stored. At this point in operation (7), the incoming packet has not yet been fully received, and thus the data for the packet continues to be received and written to the shared memory 1010. Once the packet has been fully received and written to the shared memory 1010, free buffer pointers are acquired from the forwarding control circuit 1020 as in operation (1) (operation (16)).

Upon receiving forwarding instructions from a specific input port, the forwarding control circuit 1020 registers, in the FDB 1021, the SA and VLANID contained in the forwarding instructions, as well as the port number of the originating input port (operation (8)). In addition, the forwarding control circuit 1020 also searches the FDB 1021 using the DA and VLANID, and specifies the output port 1200 from which to output the current incoming packet (operation (9)). Subsequently, the forwarding control circuit 1020 outputs forwarding instructions containing the buffer pointer to the specified output port 1200 (operation (10)).

Having received the forwarding instructions, the output control circuit 1210 of the output port 1200 reads out packet data from the region indicated by the buffer pointer for the shared memory 1010 (operation (11)). In addition, the FCS calculator 1211 calculates the FCS for the read-out packet data (operation (12)). Furthermore, the output control circuit 1210 begins outputting the read-out packet data (operation (13)). Once the outputting of the packet data has completed, the output control circuit 1210 outputs the FCS that was calculated by the FCS calculator 1211, and completes the forwarding process (operation (14)). The output control circuit 1210 then returns the buffer pointer that was used for this process to the forwarding control circuit 1020, and the forwarding control circuit 1020 registers the buffer pointer in the free buffer pointer queue 1022 (operation (15)).

As indicated by “DELAY TIME” in FIG. 2, if an ACL function is simply applied to the cut-through technique, an amount of time between packet reception and packet output increases significantly.

Using FIG. 3, operation will now be described for the case where it is determined that a packet should be discarded in an access control process executed by the ACL unit 1111.

The input control circuits 1110 of the input ports 1100 respectively acquire, from the forwarding control circuit 1020, a free buffer pointer registered in the free buffer pointer queue 1022, which points to a free region within the shared memory 1010 (operation (21)). Subsequently, when a packet arrives at one of the input ports 1100, that input port 1100 receives the packet (operation (22)), and also begins to write the packet data to the region in the shared memory 1010 indicated by the free buffer pointer (operation (23)). Also, at the same time, the address extractor 1112 of the input control circuit 1110 extracts the DA, SA, and VLANID from the incoming packet (operation (24)), and the ACL unit 1111 initiates analysis of the incoming packet (operation (25)).

If the ACL unit 1111 subsequently finishes analysis of the incoming packet and determines that, for example, the packet is to be discarded (operation (26)), then the ACL unit 1111 returns the buffer pointer to the forwarding control circuit 1020 (operation (27)), and discards any subsequent data of the incoming packet (operation (28)). In addition, free buffer pointers are acquired from the forwarding control circuit 1020 as in operation (21) (operation (29)).

In the case where it is thus determined by the ACL unit 1111 that a packet is to be discarded, neither the forwarding control circuit 1020 nor the output ports 1200 perform any actions. For this reason, the packet discarding is efficient, and no other problems arise, since the packet to be discarded does not escape the network connection apparatus where the discarding takes place. However, as described earlier, there is a problem in that the delay time increases, despite using the cut-through technique.

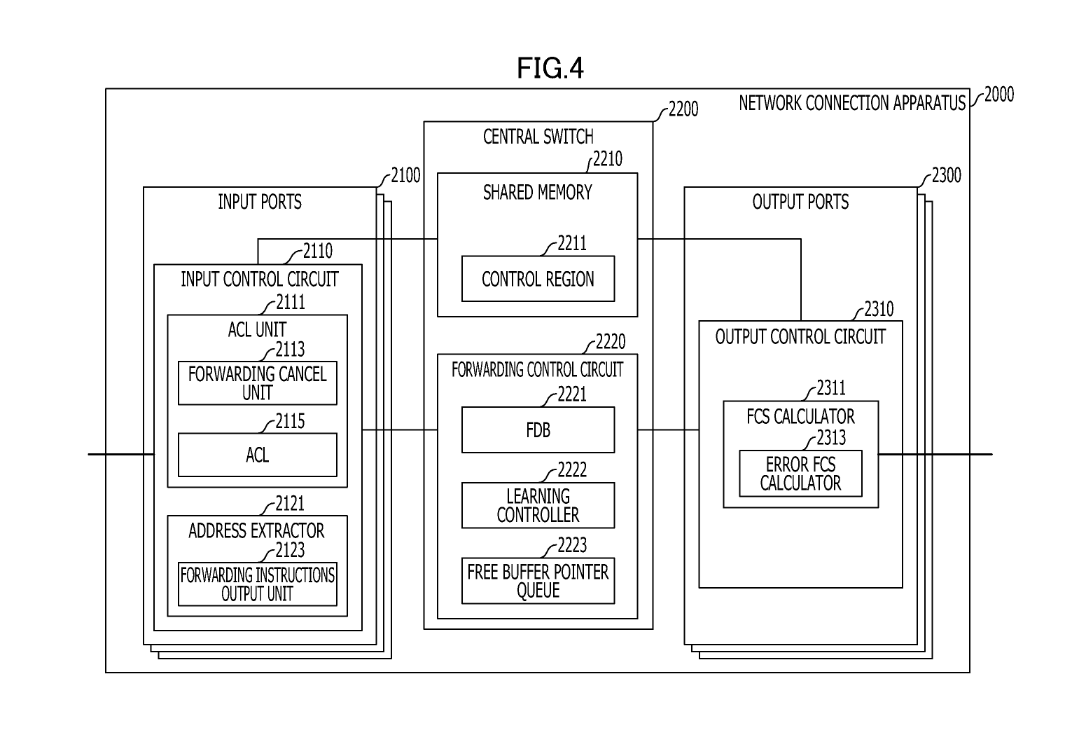

FIG. 4 is a function block diagram illustrating a network connection apparatus 2000 in accordance with an embodiment. The network connection apparatus 2000 includes a plurality of input ports 2100, a central switch 2200, and a plurality of output ports 2300.

Each of the input ports 2100 includes an input control circuit 2110. The input control circuit 2110 includes an ACL unit 2111 and an address extractor 2121. The ACL unit 2111 also includes a forwarding cancel unit 2113 and an ACL 2115. In addition, the address extractor 2121 includes a forwarding instructions output unit 2123.

The shared memory 2210 of the central switch 2200 includes a region for storing packet data, as well as a control region 2211 that stores control information. The forwarding control circuit 2220 includes an FDB 2221, a learning controller 2222, and a free buffer pointer queue 2223.

The output control circuit 2310 for each output port 2300 includes an FCS calculator 2311. The FCS calculator 2311 includes an error FCS calculator 2313 that calculates an error FCS.

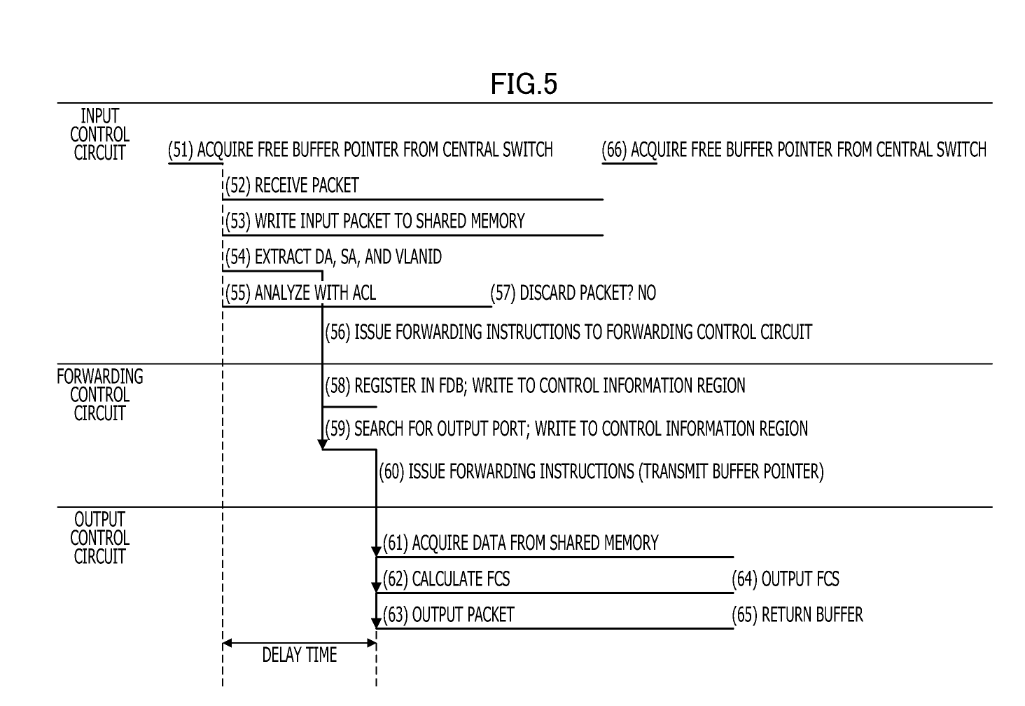

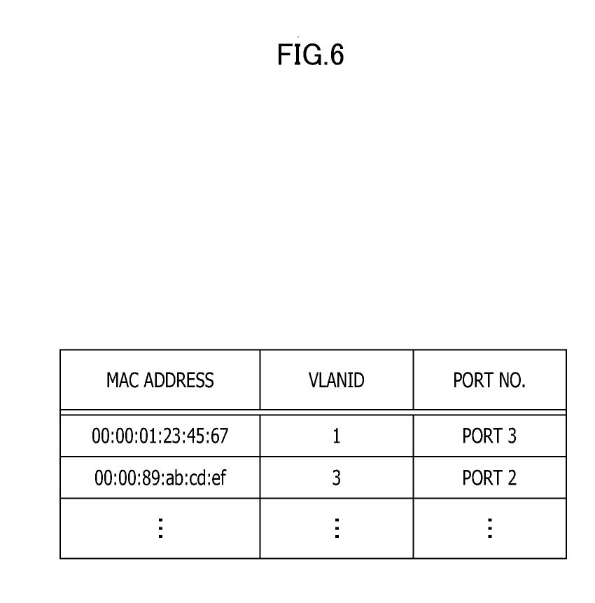

The operation of the network connection apparatus 2000 in accordance with an embodiment will now be described using FIGS. 5 and 6.

The input control circuits 2110 of the input ports 2100 respectively acquire, from the forwarding control circuit 2220, a free buffer pointer registered in the free buffer pointer queue 2223, which points to a free region within the shared memory 2210 (FIG. 5: operation (51)). Subsequently, when a packet arrives at one of the input ports 2100, that input port 2100 receives the packet (operation (52)), and also begins to write the packet data to the region in the shared memory 2210 indicated by the free buffer pointer (operation (53)). Also, at the same time, the address extractor 2121 of the input control circuit 2110 extracts the DA, SA, and VLANID from the incoming packet (operation (54)), and the ACL unit 2111 initiates analysis of the incoming packet using the ACL 2115 (operation (55)). As described earlier in the description of the related art, the ACL is data for specifying packets to be discarded, such as MAC addresses, IP addresses, and TCP port numbers, for example. In the example shown in FIG. 2, forwarding instructions were not output until the ACL unit finished analysis, even if that occurred after the address extractor extracted the DA or similar information. For this reason, the delay time was increased.

In contrast, in an embodiment, once the address extractor 2121 completes extraction of the DA or similar information, the forwarding instructions output unit 2123 of the address extractor 2121 outputs forwarding instructions containing the DA, SA, VLANID, and buffer pointer to the forwarding control circuit 2220 (operation (56)). However, as shown in FIG. 5, the ACL unit 2111 has not finished analysis at this point.

Having received the forwarding instructions, the learning controller 2222 of the forwarding control circuit 2220 carries out a learning process in order to register in the FDB 2221 the SA, VLANID, and port number of the input port 2100 that output the forwarding instructions, which are included in the forwarding instructions (operation (58)). As shown by way of example in FIG. 6, SAs (herein MAC addresses), VLANIDs, and port numbers are stored in association with each other in the FDB 2221.

In addition, the learning controller 2222 registers control information in association with a buffer pointer in the control region 2211. The control information herein is the DA, SA, and VLANID, as well as the port number of the input port 2100 that output the forwarding instructions. The control information is saved for use in case forwarding cancel instructions are later received.

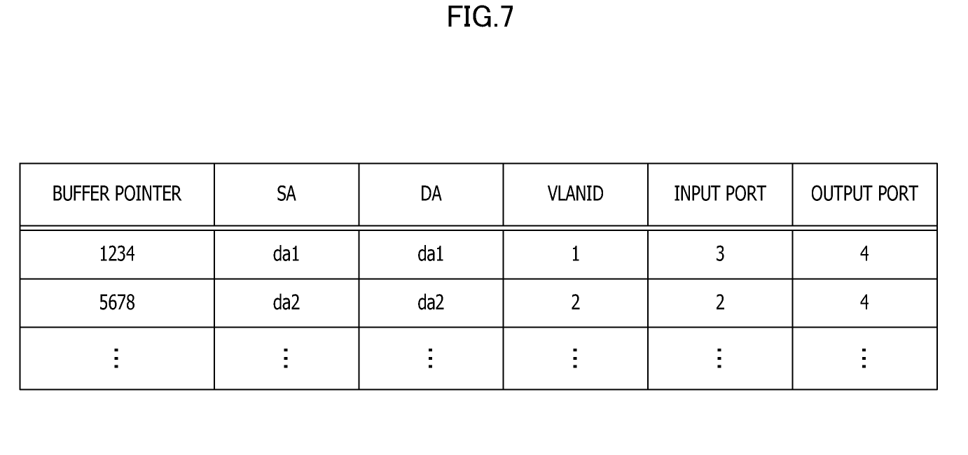

The learning controller 2222 also searches the FDB 2221 using the DA and VLANID, and specifies the output port 2300 from which to output the current incoming packet (operation (59)). In addition, the port number of the specified output port 2300 is registered in association with a buffer pointer in the control region 2211 as control information. As shown in FIG. 7, as a result of this process, the SA, DA, VLANID, port number of the input port, and port number of the output port are registered in association with a buffer pointer in the control region 2211, for example.

Subsequently, the forwarding control circuit 2220 outputs forwarding instructions containing the buffer pointer to the specified output port 2300 (operation (60)). Having received the forwarding instructions, the output control circuit 2310 of the output port 2300 begins to read out data from the shared memory 2210 in accordance with the received buffer pointer (operation (61)). In addition, the FCS calculator 2311 begins to calculate an FCS from the read-out packet data (operation (62)). Furthermore, the error FCS calculator 2313 calculates an error FCS that has an incorrect value and is different from the original FCS. For example, the error FCS calculator 2313 may add a predetermined value (such as 1) to the calculation result from the FCS calculator 2311. Meanwhile, the output control circuit 2310 begins outputting the read-out packet data (operation (63)).

In this way, the forwarding instructions are propagated to the output port 2300 and the incoming packet begins to be output before analysis by the ACL unit 2111 is complete, thereby reducing the delay time.

Herein, while the processing from operations (61) to (63) is proceeding, the analysis by the ACL unit 2111 is completed, and it is determined that the packet is not to be discarded (operation (57)). In this case, the processing from operations (61) to (63) is conducted until the output of all data for the incoming packet finishes, with the output control circuit 2310 of the output port 2300 finally outputting the FCS calculated by the FCS calculator 2311 (operation (64)). The error FCS computed by the error FCS calculator 2313 is discarded. The output control circuit 2310 then returns the buffer pointer that was used for this process to the forwarding control circuit 2220 (operation (65)), and the forwarding control circuit 2220 stores the buffer pointer in the free buffer pointer queue 2223.

Once both packet reception and packet writing are complete, the input control circuits 2110 of the input ports 2100 acquire free buffer pointers from the forwarding control circuit 2220, as in operation (51) (operation (66)).

As described above, in the case where packet discarding is not determined in the ACL unit 2111, packet output is begun early, and the delay time is reduced. However, if it is determined in the ACL that the packet is to be discarded, the forwarding instructions should be canceled, since the forwarding instructions are already being output.

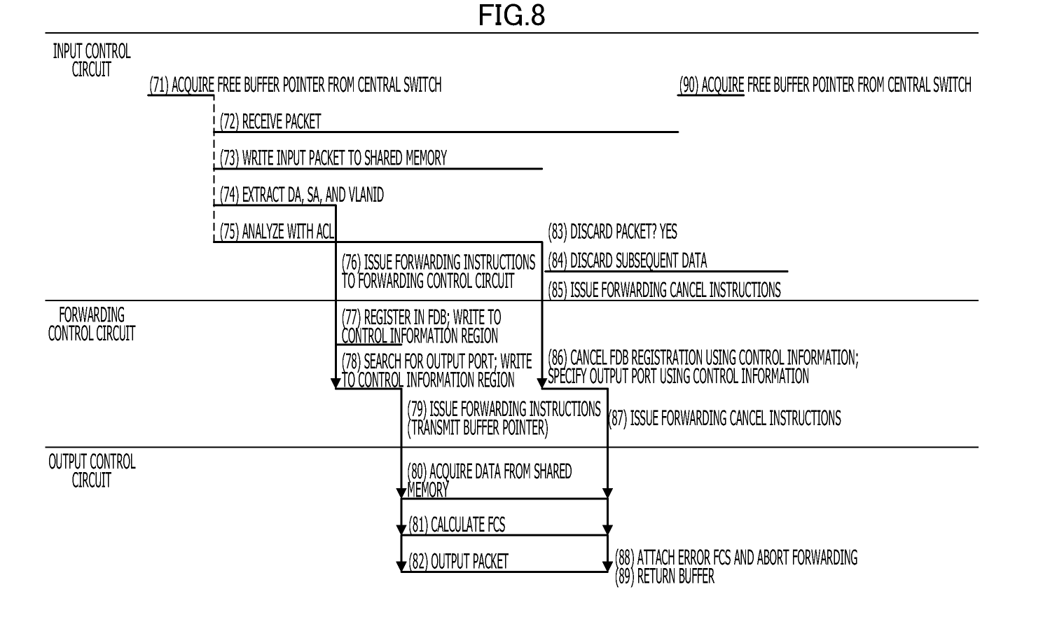

Using FIG. 8, operation will now be described for the case where it is determined by the ACL unit 2111 that a packet is to be discarded. The input control circuits 2110 of the input ports 2100 respectively acquire, from the forwarding control circuit 2220, a free buffer pointer registered in the free buffer pointer queue 2223, which points to a free region within the shared memory 2210 (FIG. 8: operation (71)). Subsequently, when a packet arrives at one of the input ports 2100, that input port 2100 receives the packet (operation (72)), and also begins to write the packet data to the region in the shared memory 2210 indicated by the free buffer pointer (operation (73)). Also, at the same time, the address extractor 2121 of the input control circuit 2110 extracts the DA, SA, and VLANID from the incoming packet (operation (74)), and the ACL unit 2111 initiates analysis of the incoming packet using the ACL 2115 (operation (75)).

In an embodiment, once the address extractor 2121 completes extraction of the DA or similar information, the forwarding instructions output unit 2123 of the address extractor 2121 outputs forwarding instructions to the forwarding control circuit 2220 containing the DA, SA, VLANID, and buffer pointer (operation (76)).

Having received the forwarding instructions, the learning controller 2222 of the forwarding control circuit 2220 carries out a learning process in order to register in the FDB 2221 the SA, VLANID, and port number of the input port 2100 that output the forwarding instructions, which are included in the forwarding instructions (operation (77)).

Furthermore, the learning controller 2222 registers control information in association with the buffer pointer in the control region 2211. The control information herein is the DA, SA, VLANID, and port number of the input port 2100 that output the forwarding instructions.

The learning controller 2222 also searches the FDB 2221 using the DA and VLANID, and specifies the output port 2300 from which to output the incoming packet (operation (78)). In addition, the port number of the specified output port 2300 is registered in association with a buffer pointer in the control region 2211 as control information.

Subsequently, the forwarding control circuit 2220 outputs forwarding instructions containing the buffer pointer to the specified output port 2300 (operation (79)). Having received the forwarding instructions, the output control circuit 2310 of the output port 2300 begins to read out data from the shared memory 2210 in accordance with the received buffer pointer (operation (80)). In addition, the FCS calculator 2311 begins to calculate an FCS from the read-out packet data (operation (81)). Furthermore, the error FCS calculator 2313 calculates an error FCS, such as by adding a predetermined value (such as 1) to the calculation result from the FCS calculator 2311. Meanwhile, the output control circuit 2310 begins outputting the read-out packet data (operation (82)). The process up to this point is the same as that shown in FIG. 5.

Subsequently, the analysis by the ACL unit 2111 is completed, and it is determined that the packet is to be discarded (operation (83)). In this case, the process conducted up to this point should be canceled, and the already read-out packet data should be discarded.

Consequently, the input control circuit 2110 discards any subsequent data of the packet being received (operation (84)), and outputs forwarding cancel instructions containing the buffer pointer to the forwarding control circuit 2220 (operation (85)).

Upon receiving the forwarding cancel instructions, the forwarding control circuit 2220 reads out, from the shared memory 2210, the control information stored in association with the buffer pointer in the control region 2211. The forwarding control circuit 2220 then cancels the registration in the FDB 2221 by using the SA, VLANID, and port number of the input port 2100 that are contained in the control information (operation (86)). For example, the record containing the SA, VLANID, and port number of the input port 2100 may be deleted from the FDB 2221. The forwarding control circuit 2220 then outputs forwarding cancel instructions containing the buffer pointer to the output control circuit 2310 of the output port 2300 specified by the output port number contained in the control information (operation (87)).

Upon receiving the forwarding cancel instructions, the output control circuit 2310 of the output port 2300 aborts the reading and outputting of packet data from the shared memory 2210, the FCS calculator 2311 aborts the FCS calculation, and the error FCS calculator 2313 also finishes the error FCS calculation. The output control circuit 2310 finally outputs the error FCS, and terminates the forwarding process (operation (88)). The output control circuit 2310 then returns the buffer pointer to the forwarding control circuit 2220 (operation (89)). Upon receiving the buffer pointer from the output control circuit 2310, the forwarding control circuit 2220 registers the buffer pointer in the free buffer pointer queue 2223.

Once packet reception is complete, the input control circuits 2110 of the input ports 2100 acquire free buffer pointers from the forwarding control circuit 2220 (operation (90)).

By carrying out such a process, packets are invalidated, which in effect prevents the escape of packets that occurs as a result of immediately outputting forwarding instructions.

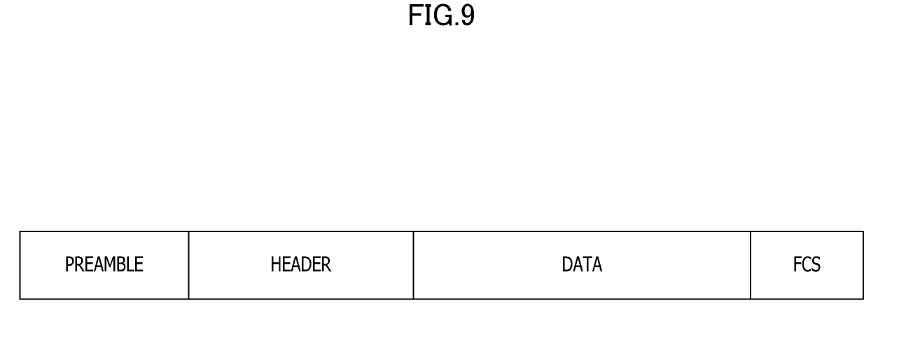

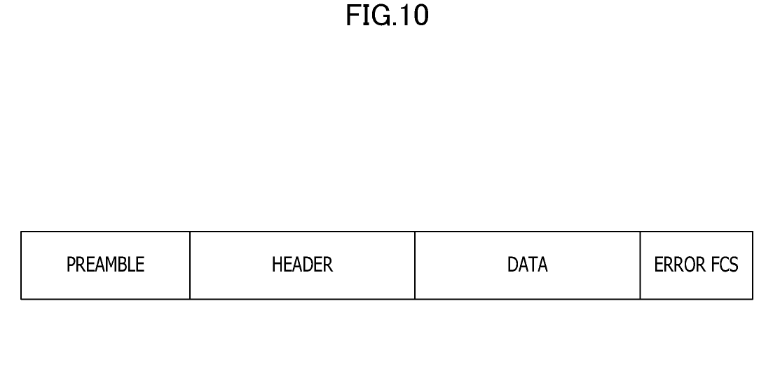

An ordinary packet (also referred to as a frame) will contain a preamble, a header (which includes the SA, DA, and VLANID), data, and a valid FCS, as shown in FIG. 9. In contrast, as shown in FIG. 10, an invalid packet will contain a preamble and a header just like an ordinary packet, but the data will be cut off, and an error FCS will also be attached. For this reason, such packets will be automatically discarded, without modifying the input ports of the receiving network connection apparatus.

However, packet invalidation is also achievable by implementing other means. For example, a bit sequence indicating that the packet is invalid and a valid FCS may be attached after the data. In this case, the input ports of the receiving network connection apparatus must be able to recognize the bit sequence indicating that the packet is invalid. Furthermore, since it is sufficient for the already output packet data to be discarded by the receiver, in an Ethernet (tm) environment the output port 2300 may output a jam signal upon receiving forwarding cancel instructions, thereby causing the packet to be discarded by pretending that a collision has taken place. Such a method also results in the packet being treated as invalid.

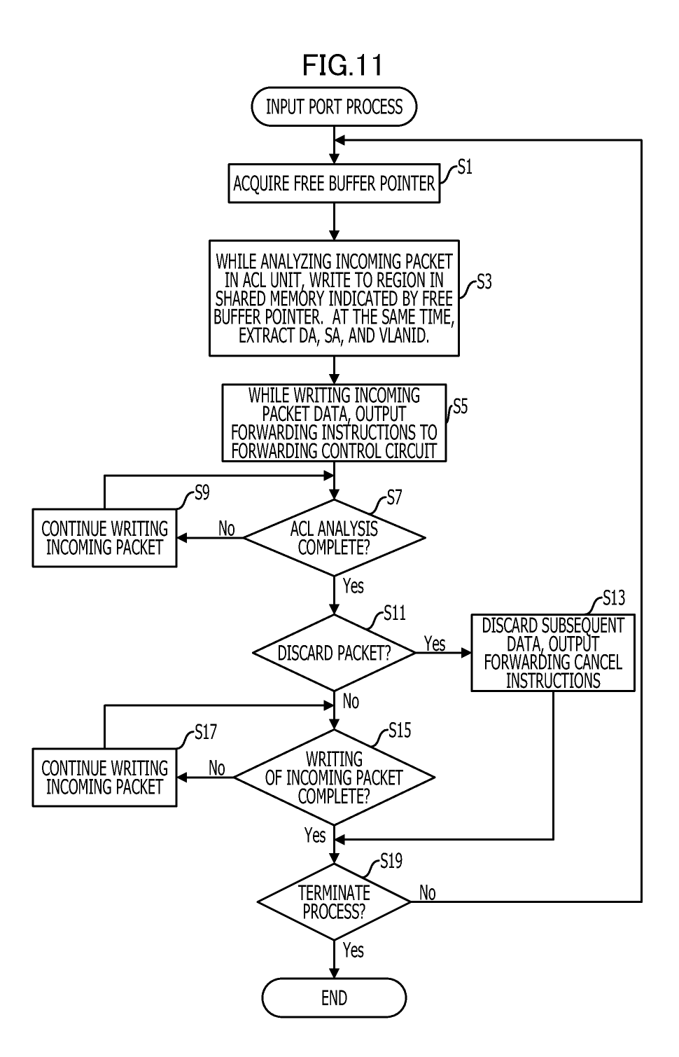

Next, the processes that are respectively executed by the input ports 2100, the central switch 2200, and the output ports 2300 will be collectively described. First, a process executed by an input port 2100 is illustrated in FIG. 11. The input control circuit 2110 of the input port 2100 acquires, from the forwarding control circuit 2220, a free buffer pointer registered in the free buffer pointer queue 2223 (operation S1). A plurality of pointers may also be acquired at once and saved for later use.

Once a packet arrives at the input port 2100, the packet begins to be received, and analysis of the incoming packet is conducted by the ACL unit 2111 of the input port 2100. Meanwhile, the incoming packet data begins to be written to the region in the shared memory 2210 indicated by a free buffer pointer, while in addition, the DA, SA, and VLANID are extracted from the incoming packet data by the address extractor 2121 (operation S3).

If the extraction of the DA, SA, and VLANID by the address extractor 2121 is completed while the input control circuit 2110 receives and writes the incoming packet to the shared memory 2210, the forwarding instructions output unit 2123 outputs forwarding instructions to the forwarding control circuit 2220 containing the DA, SA, and VLANID, as well as a buffer pointer (operation S5). In so doing, forwarding instructions are output before the analysis by means of the ACL is completed, thereby reducing the delay time.

If the ACL analysis is incomplete (operation S7: No route), then the input control circuit 2110 continues to receive and write the incoming packet to the shared memory 2210 (operation S9). In contrast, if the ACL analysis is completed (operation S7: Yes route), and the ACL unit 2111 determines that the incoming packet is to be discarded (operation S11: Yes route), then the input control circuit 2110 discards any subsequent data of the packet being received, while the forwarding cancel unit 2113 outputs forwarding cancel instructions to the forwarding control circuit 2220 containing the buffer pointer (operation S13). The process then transitions to operation S19.

In contrast, if the ACL unit 2111 determines that the packet is not to be discarded (operation S11: No route), and if the receiving and writing of the incoming packet to the shared memory 2210 is not yet complete (operation S15: No route), then the input control circuit 2110 continues to receive and write the incoming packet to the shared memory 2210 (operation S17) until the receiving and writing is completed. Once the packet has been completely received and written to the shared memory 2210 (operation S15: Yes route), the process returns to operation S1 and repeats until a process termination event such as turning off the power occurs (operation S19).

By carrying out such a process, latency values can be reduced, as described earlier. Moreover, forwarding cancel instructions can be immediately issued when determining necessity of discarding a packet.

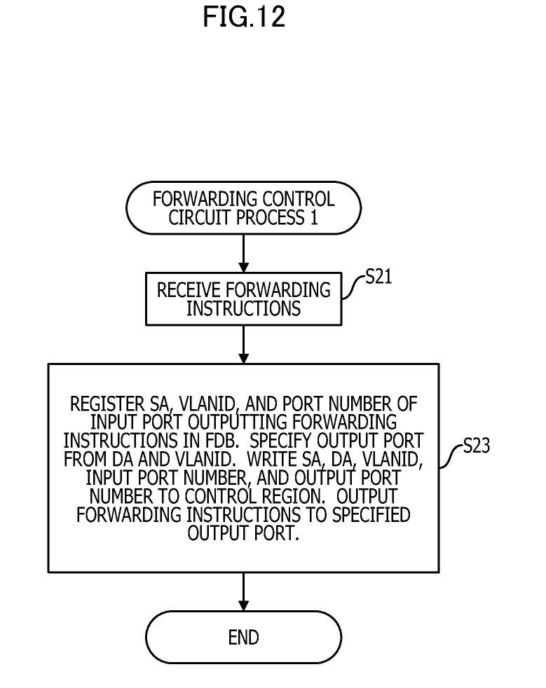

Processes executed by the forwarding control circuit 2220 of the central switch will now be separately described: one for the case of receiving forwarding instructions, and one for the case of receiving forwarding cancel instructions. First, the case of receiving forwarding instructions will be described using FIG. 12. Once the forwarding control circuit 2220 receives forwarding instructions from the input control circuit 2110 of a given input port 2100 (operation S21), the learning controller 2222 carries out a learning process in order to register in the FDB 2221 the SA, VLANID, and port number of the input port 2100 that output the forwarding instructions, which are included in the forwarding instructions. The forwarding control circuit 2220 also searches the FDB 2221 using the DA and VLANID, and specifies the corresponding output port. In addition, the forwarding control circuit 2220 writes control information in association with a buffer pointer to a control region 2211 in the shared memory 2210. The control information is the SA, DA, VLANID, and port number of the input port included in the forwarding instructions, as well as the port number of the output port. The forwarding control circuit 2220 also outputs forwarding instructions containing the buffer pointer to the specified output port 2300 (operation S23). The writing of control information to the control region 2211 is conducted in order to specify the forwarding output port for the FDB 2221 in learning cancel and forwarding cancel instructions, in case forwarding cancel instructions are later received. Herein, if forwarding cancel instructions are not received, then the process shown in FIG. 12 is completed at this point. Subsequently, the control information stored in the control region 2211 is overwritten and discarded in accordance with reuse of the buffer pointer.

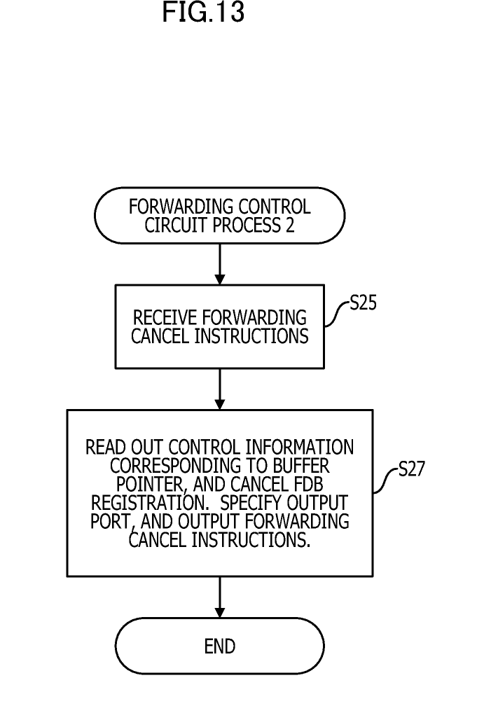

The case of receiving forwarding cancel instructions will now be described using FIG. 13. Once the forwarding control circuit 2220 receives forwarding cancel instructions from the input control circuit 2110 of a given input port 2100 (operation S25), the control information associated with the buffer pointer contained in the forwarding cancel instructions is read out from the control region 2211 of the shared memory 2210, and the learning controller 2222 cancels the registration in the FDB 2221 in accordance with the particular combination of an SA, VLANID, and port number of an input port. Furthermore, from the output port number contained in the control information, the forwarding control circuit 2220 specifies the output port 2300 that will act as the output destination for the forwarding cancel instructions. The forwarding control circuit 2220 then outputs forwarding cancel instructions containing the buffer pointer to that output port 2300 (operation S27).

In so doing, the FDB 2221 is returned to its original state, and forwarding cancel instructions are output to the appropriate output port 2300.

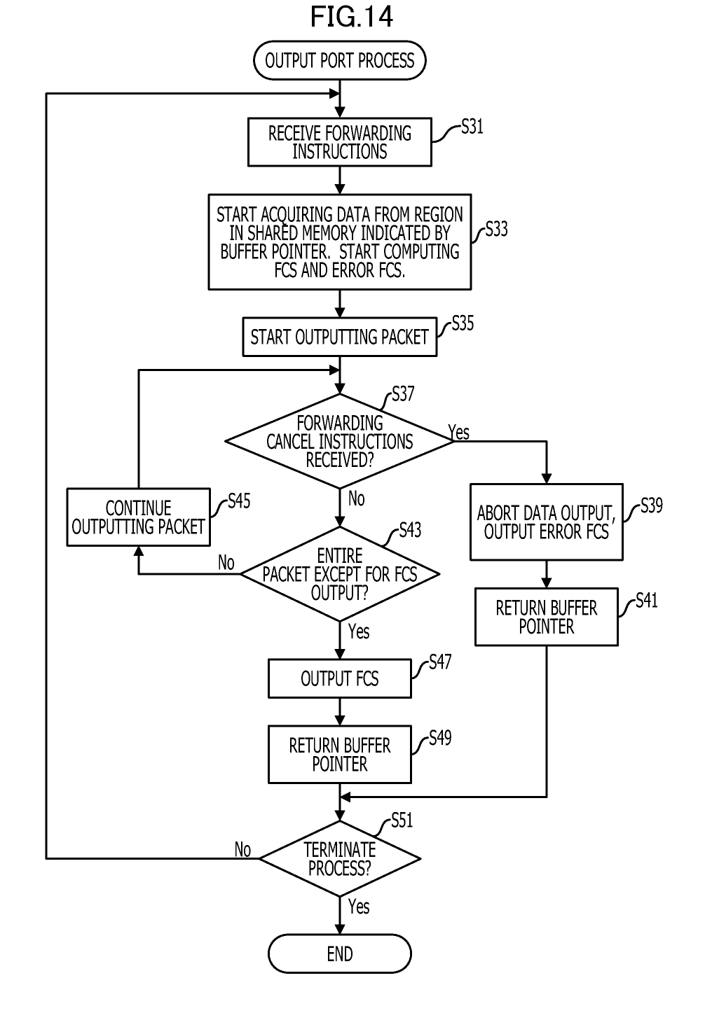

Next, a process executed by an output port 2300 will be described using FIG. 14. Upon receiving forwarding instructions (operation S31), the output control circuit 2310 of the output port 2300 begins to read out packet data from the region in the shared memory 2210 specified by the buffer pointer contained in forwarding instructions. Furthermore, the FCS calculator 2311 (including the error FCS calculator 2313) initiates calculation of an ordinary FCS and an error FCS from the read-out packet data (operation S33). As described earlier, the error FCS may be computed by adding a predetermined value to the ordinary FCS. The forwarding control circuit 2220 then begins to output the read-out packet data (operation S35).

Subsequently, upon receiving forwarding cancel instructions from the forwarding control circuit 2220 (operation S37: Yes route), the output control circuit 2310 aborts output of the packet data, and outputs the error FCS computed by the error FCS calculator 2313 after the packet data (operation S39). In so doing, the packet that was output becomes invalid, and is discarded at the input port of the receiving network connection apparatus. In effect, this is equivalent to discarding the packet before output. The output control circuit 2310 then returns the buffer pointer contained in the forwarding cancel instructions to the forwarding control circuit 2220 (operation S41). Upon receiving the returned buffer pointer, the forwarding control circuit 2220 registers the buffer pointer in the free buffer pointer queue 2223. The process then transitions to operation S51.

In contrast, if forwarding cancel instructions are not received (operation s37: No route), and if the reading out and outputting of packet data is not complete (operation S43: No route), then the output control circuit 2310 continues to read out packet data from the shared memory 2210 and output the packet data until all data for the entire packet (except the FCS) has been output (operation S45). After operation S45, the process returns to operation S37.

Meanwhile, in the case where all data for the entire packet (except the FCS) is output, and no forwarding cancel instructions were received during that time (operation S43: Yes route), the output control circuit 2310 outputs the FCS calculated by the FCS calculator 2311 (operation S47), and returns the buffer pointer contained in the forwarding instructions to the forwarding control circuit 2220 (operation S49).

As long as a power-off or similar process termination does not occur (operation S51: No route), the above process is repeated. If a process termination event does occur (operation S51: Yes route), then the process is terminated.

As a result of the above, packet data that has been output up to the current point is converted into an invalid packet in accordance with forwarding cancel instructions, which results in the packet data being discarded.

It should be appreciated that the foregoing embodiment of the present technology is merely one example, and that the present technology is not limited thereto. For example, the function block diagram of the network connection apparatus shown in FIG. 4 is merely one example, and the actual functional configuration might not match exactly in some cases. Moreover, the function block diagram in FIG. 4 only illustrates functions related to the essential matter of an embodiment, and it is possible to add other functions thereto.

The foregoing embodiment is summarized as follows.

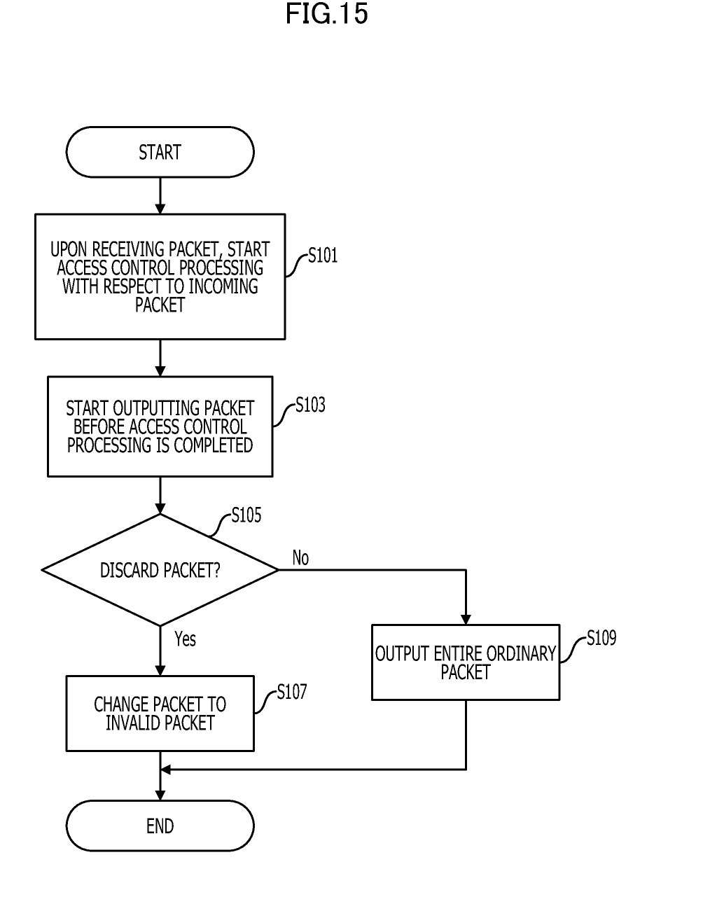

A latency reduction method in accordance with an embodiment includes an operation including: initiating the output of an incoming packet in a network connection apparatus before access control processing for that incoming packet has completed (FIG. 15: operations S101 and S103); and if it is determined by the access control processing to discard the incoming packet (operation S105: Yes route), changing the incoming packet into an invalid packet, and then outputting (operation S107).

As a result, if the packet is invalid, then the receiver will discard the packet. Therefore, even in the case of using an ACL function in conjunction with the cut-through technique, an incoming packet will be output before the completion of the access control processing in the case where the packet is not discarded. For this reason, worsened latency can be curtailed. Meanwhile, if it is not necessary to discard an incoming packet (operation S105: No route), the entire packet may be output as usual (operation S109).

The above outputting operation may also include an operation wherein the output of an incoming packet is stopped in response to a determination to discard the incoming packet, and an incorrect frame check sequence is then output after the already-output data of the incoming packet. In so doing, the escape of data from the network connection apparatus is minimized, while also enabling naturally discarded, invalid packets to be generated using existing mechanisms. On the other hand, if it is possible to modify the packet structure, then packets may be structured to include an invalid bit sequence appended at the end. A process may also be carried out to cancel address learning in response to a determination to discard an incoming packet.

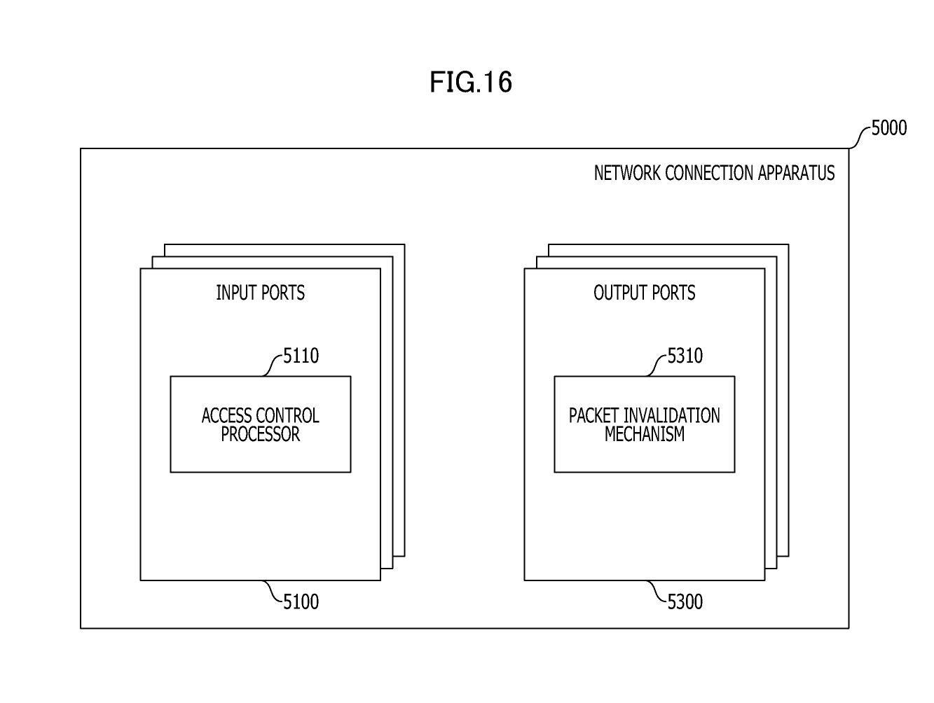

A network connection apparatus in accordance with another embodiment (FIG. 16: network connection apparatus 5000) includes a plurality of input ports (FIG. 16: input ports 5100) and a plurality of output ports (FIG. 16: output ports 5300). Each input port 5100 includes an access control processor (FIG. 16: access control processor 5110) that carries out access control processing with respect to an incoming packet. Each output port 5300 includes a packet invalidation mechanism (FIG. 16: packet invalidation mechanism 5310). Once a specific input port receives a specific packet, the access control processor for the specific input port initiates access control processing with respect to the specific packet, and the output of the specific packet from a specific output port from which the specific packet is to be output is initiated before the completion of the access control processing with respect to the specific packet. If the access control processor determines to discard the specific packet, then the packet invalidation mechanism of the specific output port changes the specific packet into an invalid packet.

In addition, the packet invalidation mechanism described above may also generate and output an incorrect frame check sequence with respect to the already-output data of the specific packet.

Furthermore, the network connection apparatus in accordance with the second aspect may be configured to additionally include shared memory, and a forwarding controller that specifies the output port from which to output a received packet. In this case, the specific input port may begin storing the data of the specific packet in the shared memory, while also outputting forwarding instructions to the forwarding controller, before the completion of the access control processing with respect to the specific packet. The forwarding controller may also specify the specific output port from which to output the specific packet in accordance with the forwarding instructions, and output forwarding instructions to the specific output port. Furthermore, having received the forwarding instructions, the output port may begin reading out the data of the specific packet from the shared memory and outputting. If the access control processor then determines to discard the specific packet, the specific input port may then output instructions to discard the specific packet to the forwarding controller, with the forwarding controller outputting the instructions to discard the specific packet to the specific output port. Subsequently, in response to the instructions to discard the specific packet, the specific output port may abort output of the data of the specific packet, and then output data that has been generated by the packet invalidation mechanism, and which changes the specific packet into an invalid packet. Herein, the data of the specific packet may be specified by a buffer pointer, which indicates the region in the shared memory where the specific packet is stored, and which is delivered using the forwarding instructions and discarding instructions. The forwarding controller may then manage the specific output port or other data by using the buffer pointer.

In the foregoing embodiment, the worsening of latency values can be curtailed including in the case of applying an ACL function to the cut-through technique. According to an embodiment, a method of reducing latency is provided that includes outputting a forwarding instruction without requiring an ACL analysis to be completed where the forwarding instruction may be issued while processing packet data.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media. The program/software implementing the embodiments may also be transmitted over transmission communication path. Examples of the non-transitory computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention, the scope of which is defined in the claims and their equivalents.

What is claimed is:

1. A latency reduction method executed by a network connection apparatus, the latency reduction method comprising:
starting to output an incoming packet before an access control processing with respect to the incoming packet has completed; and
changing the incoming packet to an invalid packet and outputting the invalid packet when determining by the access control processing to discard the incoming packet.

2. A latency reduction method executed by a network connection apparatus, the latency reduction method comprising:
starting to output an incoming packet before an access control processing with respect to the incoming packet has completed; and
stopping the output of the incoming packet in response to a determination to discard the incoming packet, and outputting an incorrect frame check sequence after an already-output data of the incoming packet.

3. A network connection apparatus, comprising:
a plurality of input ports, each having an access control processor that carries out an access control processing with respect to an incoming packet; and
a plurality of output ports, each having a packet invalidation mechanism, and
wherein once a specific input port receives a specific packet, an access control processing for the specific input port initiates an access control processing with respect to the specific packet, and the output of the specific packet from a specific output port from which the specific packet is to be output is initiated before completion of the access control processing with respect to the specific packet, and
when the access control processor determines to discard the specific packet, then the packet invalidation mechanism of the specific output port changes the specific packet into an invalid packet.

4. The network connection apparatus according to claim 3, wherein the packet invalidation mechanism generates and outputs an incorrect frame check sequence with respect to an already-output data of the specific packet.

5. The network connection apparatus according to claim 3, comprising:
a shared memory; and
a forwarding controller that specifies the output port from which to output a received packet;
wherein the specific input port begins storing the data of the specific packet in the shared memory, while also outputting forwarding instructions to the forwarding controller, before the completion of the access control processing with respect to the specific packet,
the forwarding controller specifies the specific output port from which to output the specific packet in accordance with the forwarding instructions, and outputs forwarding instructions to the specific output port,
the output port begins reading out the data of the specific packet from the shared memory and outputting subsequent to having received the forwarding instructions,
when the access control processor determines to discard the specific packet, the specific input port outputs instructions to discard the specific packet to the forwarding controller,
the forwarding controller outputs the instructions to discard the specific packet to the specific output port, and
the specific output port aborts output of the data of the specific packet in response to the instructions to discard the specific packet, outputting data that has been generated by the packet invalidation mechanism, and which changes the specific packet into an invalid packet.
